(19) United States
(12) Patent Application Publication
(10) Pub. No.: US 2005/0284585 A1
(43) Pub. Date: Dec. 29, 2005

(54) Light and vision blocking venetian blind

(76) Inventor: Timothy N. Taylor, Red Bank, NJ (US)

Correspondence Address: Randy Shay, PO Box 2607, Fairfax, VA, 22031, US

(21) Appl. No.: 10/876,559

(22) Filed: Jun. 28, 2004

(51) Int. Cl. E06B 9/30

(52) U.S. Cl. 160/172 R

(57) ABSTRACT

A venetian blind system having an improved method for prohibiting light infiltration and line of sight vision through the closed blind and an improved method for preventing the blowing or flapping of the blind is disclosed. Unique “S” shaped slats, which allow uninhibited light flow and line of sight vision through the blind when in the open position, interlace in the closed position to greatly improve blockage of light and line of sight vision. End channels attached to the vertical sides of the window receive the ends of the blind slats, preventing flapping. Vertical end slats hingedly attached to the end channels maintain contact with the front and rear edges of the blind slats, whether in the opened or closed position, adding additional protection from light infiltration or line of sight vision around the ends of the blind.

### BACKGROUND OF THE INVENTION

1. Field of the Invention

The present invention relates to window blinds. More particularly, the invention comprises a unique venetian blind which provides improved light and line of sight obstruction over many of the prior art blinds.

2. Description of the Prior Art

Adjustable window blinds, including venetian blinds, have been known in the art for many years, with a number of improvements in recent years. Existing blinds provide varying degrees of protection against light filtration and line of sight vision.

U.S. Pat. No. 6,433,498, issued to Douglas R. Domel, et al., on Aug. 13, 2002, presents a HEAD RAIL-MOUNTED ACTUATOR FOR WINDOW COVERINGS. A motor mounted within a housing in the head rail of a window covering is variously attached to the window covering such that the slats of a venetian blind are opened and closed, a venetian or pleated shade is raised or lowered, the vertical slats of vertical blinds are rotated, the roller of a roll up shade is rotated, or the traverse rod is actuated to open and close vertical blinds or curtains. The motor may be actuated by a switch, a light sensor, adjusting the window covering as ambient light increases/decreases, or by remote control device.

U.S. Pat. No. 6,405,783, issued to Brian W. Smith on Jun. 18, 2002, discloses a HORIZONTAL WINDOW BLIND APPARATUS. A plurality of substantially horizontal slats are each cantilevered from tabs moveably attached to and suspended from a frame at the top of a window opening. Smith, however, lacks the “S” shape of the horizontal slats and the end channels and slats and bottom rail of the present invention, which block direct light infiltration and line of sight vision.

In U.S. Pat. No. 6,371,193, issued on Apr. 16, 2002 to Barry Goodman, a CONTOURED RIGID VANE FOR ARCHITECTURAL COVERING, which is adapted for use in either vertical or horizontal blinds, is disclosed. Once again, Goodman's vane lacks the pronounces “S” curve, and the rails and end slats and bottom rail, which block direct light infiltration and line of sight vision.

James Love, et al., disclose WINDOW BLINDS in U.S. Pat. No. 6,318,441, issued on Nov. 20, 2001. Love, et al., disclose a unique suspension mechanism which provides uniform rotation of each slat, but again lack the “S” curve of the horizontal slats and the end channels and slats and bottom rail of the present invention.

A BLACKOUT BLIND is disclosed in U.S. Pat. No. 5,957,183, issued to Kendall W. Prince on Sep. 28, 1999. Prince discloses a blind which gives an improved protection against light infiltration, but lacks the end channels and slats and bottom rail of the present invention which prevent light infiltration and line of sight vision around the ends of the blinds.

None of the above inventions and patents, taken either singly or in combination, is seen to describe the instant invention as claimed.

### SUMMARY OF THE INVENTION

The present invention consists of a venetion blind, similar in operation to most prior art venetian blinds. The present invention, however, distinguishes from the prior art in that each horizontal slat, has an “S” curve in its narrow, depth, dimension such that when in a closed state, the ends of the “S”s overlap and abut the adjacent slats to provide an improved shield against light infiltration between the slats. Additionally, a pair of slats attached to an end piece on each of the two ends of the blind overlaps the ends of the horizontal slats and adjust to maintain a close relationship to the horizontal slats as they are opened and closed, thereby providing light infiltration and line of sight obstruction not found in prior art. A bottom rail, which receives the bottom horizontal slat into a grooved interior provides even further line of sight and light infiltration protection. The end slats and bottom rail have the added benefit of limiting the movement of the blind within the window frame, as might be caused by drafts or other disturbances, as well as providing a more finished appearance.

Accordingly, it is a principal object of the invention to provide a venetian blind which provides improved line of sight obstruction through or around the blind.

It is another object of the invention to provide a venetian blind which provides improved light infiltration protection.

It is a further object of the invention to provide a venetian blind which has improved movement restriction to keep the blind from blowing in a draft, thereby allowing light infiltration or line of sight vision.

Still another object of the invention is to provide a venetian blind which is relatively inexpensive to manufacture, and install.

An additional object of the invention is to provide a venetian blind which is durable.

It is again an object of the invention to provide a venetian blind which is attractive.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an exploded, perspective view of the blinds of the present invention.

FIG. 2A is a cross sectional view, at line A-A, FIG. 1, of the blind of the present invention, detailing the horizontal slats in a open position.

FIG. 2B is a cross sectional view, at line A-A, FIG. 1, of the blind of the present invention, detailing the horizontal slats in an closed position.

FIG. 3A is a partial cross sectional view, at line B-B, FIG. 1, of the blind of the present invention, detailing the end slats with the horizontal slats in an open position.

FIG. 3B is a partial cross sectional view, at line B-B, FIG. 1, of the blind of the present invention, detailing the end slats with the horizontal slats in an closed position.

FIG. 4 is a partial cross sectional view, at line A-A, FIG. 1, of the blind of the present invention, detailing the bottom rail and channel of the blind.

FIG. 5 is an orthographic top view of one of the horizontal slats of the blind of the present invention.

### DETAILED DESCRIPTION OF THE PREFERRED EMBODIMENTS

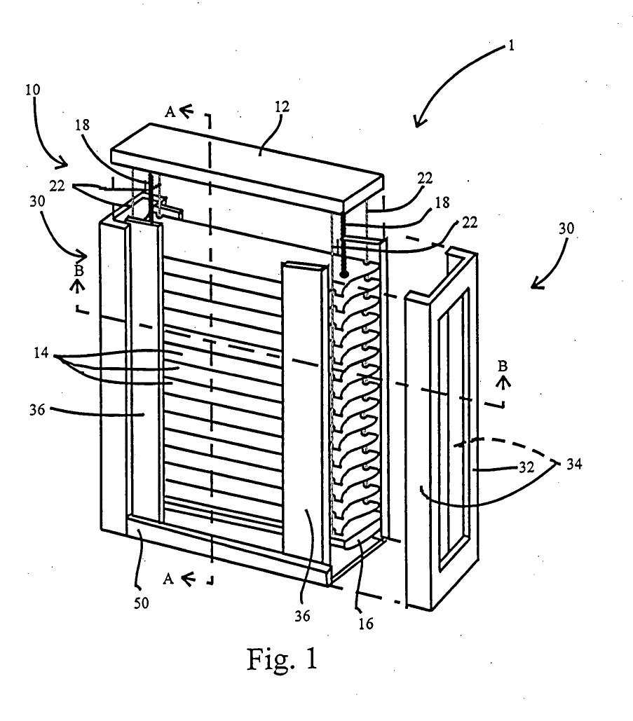

As depicted in FIG. 1, blind 10 of the light and vision blocking venetian blind 1 of the present invention is quite similar to blinds in the prior art, consisting of a head rail 12, a plurality of horizontal slats 14, and a weighted bottom rail 16, which are mechanically controlled by a pair of draw cords 18 which raise and lower the blind and front and rear linking cords 22 which control the tilt of the slats 14. While linking cords 22 are depicted as a relatively thin cord, it is understood by those of skill in the art that the linking cords 22 could be of the nature of a wide, cloth, or similar material, ribbon or other flexible connector such as a metal wire or cable. The mechanics of the operation of the basic blind is not deemed to be a part of the present invention, and will not be discussed in detail. The inventive elements of the present blind, however, will be disclosed, in detail, hereinbelow.

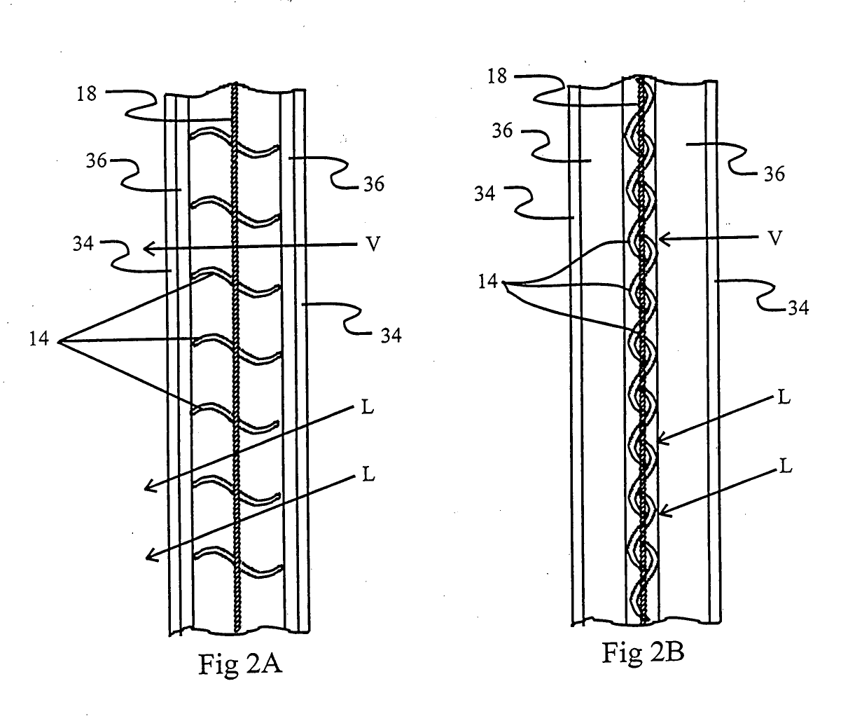

The slats 14 of the present invention, as depicted in FIG. 1, have a length substantially equal to the width of a window into which the blind is installed, a width, and a nominal thickness. The slats 14 may be of a variety of materials, including, but certainly not limited to, metal, plastic or wood. It would be evident that the thickness of the slats 14 may vary, depending on the material from which they are constructed. It may easily be seen at FIGS. 2A and B, that the slats 14 have a unique cross-sectional profile resembling an open letter “S”, which, when the blind is in the open position, as at FIG. 2A, allows light (L) infiltration and line of sight vision (V) through the blind. When the blind is closed, however, as at FIG. 2B, the opposite ends of the “S” of adjacent slats interlace and the edges abut the surface of the two adjacent slats to effectively block light (L) infiltration and line of sight vision (V).

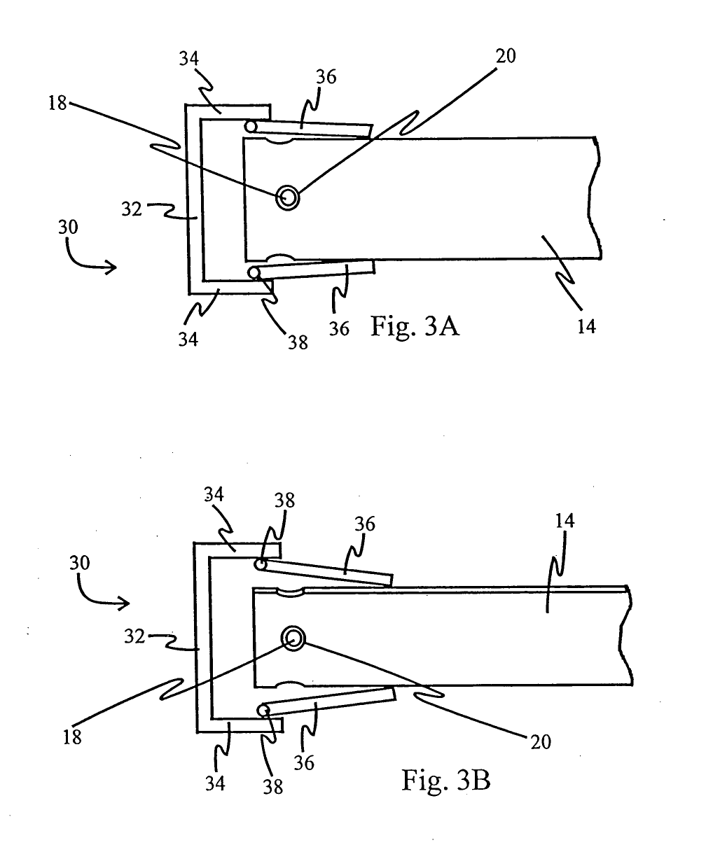

As depicted at FIGS. 1, 3A and 3B, the light and vision blocking venetian blind 1 of the present invention further consists of a pair of end channels 30, one mounted on each side of a window frame, each of which encases one end of the head rail 12, slats 14 and bottom rail 16. Each end channel 30 has an end plate 32 and a front channel and rear channel rail 34, front channel rail 34 being substantially normal to a front edge of end plate 32 and rear channel rail 34 being substantially normal to a rear edge of end plate 32, thereby forming a “U” shaped end channel 30.

An end slat 36, having a length substantially equal to the height of the window into which the light and vision blocking venetian blind 1 is to be mounted, minus the height of top rail 12, is attached internal of each front and rear channel rail 34 by a spring hinge 38 such that each end slat 36 extends over the end of the horizontal slats 14. The spring of hinge 38 causes the free edge of each end slat 36 to remain in movable contact with the slats 14 when the blind 10 is in an open position, as at FIG. 3A or in a closed position, as at FIG. 3B, or at any intermediate position, thereby barring light infiltration or line of sight vision around the ends of the slats 14. Additionally, the combination of the end channel 30 and end slat 36 prevents the blind 10 form blowing out from the window frame due to drafts or when the window is open.

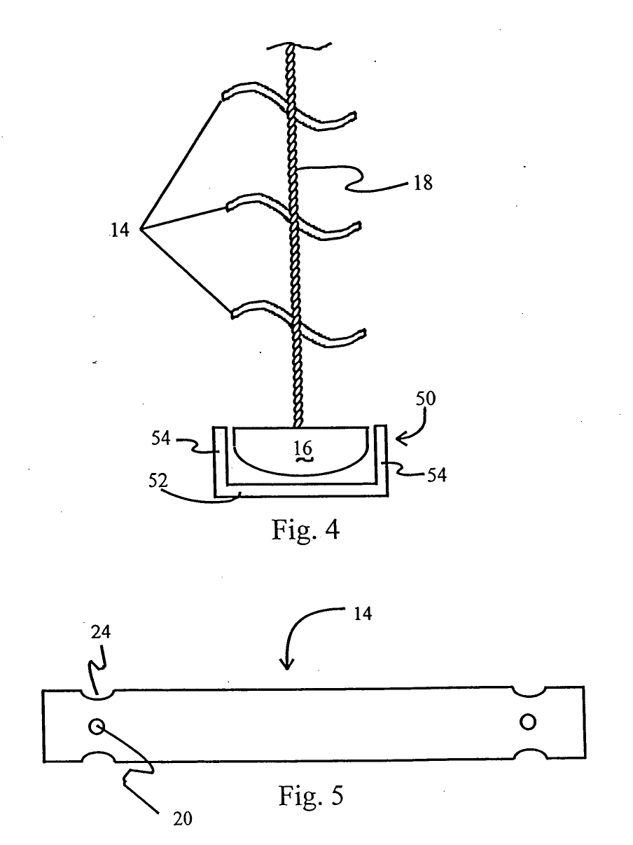

FIG. 4 depicts the bottom rail 16 and bottom channel 50 of the present invention. The bottom rail 16 consists of a relatively solid member having a length substantially equal to the length of the blind 1, a width substantially equal to the width of the slats 14, and a height. Bottom rail 16 gives the blind 1 weight at its lower end, thereby limiting the flapping of blind 1 in drafts. A sill channel 50 is mounted to the sill into which the blind 1 is installed. Sill channel 50 consists of a bottom plate 52 and front and rear channel walls 54, front and rear channel walls 54 being substantially normal to bottom plate 52. In profile, sill channel 50 is configured and dimensioned substantially the same as the end channels 30, such that sill channel 50 and the end channels 30 form a continuous channel around the sides and bottom of blind 1. The bottom rail 16 of blind 1 is dimensioned to fit within the interior of sill channel 50 and end channels 30.

As depicted in FIGS. 3A, 3B and 5, each slat 14 further consists of a draw cord aperture 20 for each draw cord 18 of the blind 1 and a front and rear linking cord notch 24 for each linking cord 22. Draw cord apertures 20 are typically round, allowing the draw cords 18 to freely pass as the blind 1 is raised or lowered, while the linking cord notches 24 are configured to accommodate the shape and size of the linking cords 22, thereby allowing the edges of each slat 14 to fully abut the surfaces of the adjacent slats 14 without cutting into the linking cords 22. A suspension cord (not shown) connects the two related front and rear linking cords 22, each suspension cord suspending a slat 14 thereon. Ideally, the draw cord apertures 20 and linking cord notches 24 are situated along the length of the slats 14 such that they are concealed behind the end slats 36.

It is to be understood that the present invention is not limited to the embodiments described above, but encompasses any and all embodiments within the scope of the following claims.

1. A light and vision blocking venetian blind system comprising:
a venetian blind comprising:
a horizontal head rail removably mountable to a top of a window opening,
a plurality of horizontal slats, and
a weighted, horizontal bottom rail,
said slats and bottom rail being movably and rotatably joined to said top rail by:
at least two vertical draw cords, and
at least two pair of front and rear linking cords; and
vertical constrainment means for constraining the two ends of said blind; and
horizontal constrainment means for constraining said bottom rail.

2. The light and vision blocking venetian blind system, as defined in claim 1, wherein each of said horizontal slats, in cross section, have an “S” shaped profile, the opposite ends of the “S” of adjacent slats interlacing and abutting a surface of each adjacent slat when in a closed state, whereby, when in an open state, light infiltration and line of sight vision are substantially unimpaired, and when in said closed state, light infiltration and line of sight vision are substantially restricted.

3. The light and vision blocking venetian blind system, as defined in claim 2 wherein each of said horizontal slats further comprises a plurality of linking cord notches formed in the edges thereof, thereby allowing said edges of each of said horizontal slats to abut said surface of each adjacent slat, passing around said linking cords without cutting into said linking cords.

4. The light and vision blocking venetian blind system, as defined in claim 1, wherein said vertical containment means comprises a pair of end channels, each of said end channels further comprising:
an end plate having a length and a width, and
a front and a rear channel rail,
said front and rear channel rails being substantially normal to and abutting each of the two length edges of said end plate, thereby generally forming a “U” shape,
one of said end channels being mountable to each of the two sides of a window opening such that the ends of said slats and bottom rail are constrained within said “U”s, thereby limiting the free movement of said blind beyond the limits of said end channels and restricting light infiltration and line of sight vision around said ends of said blind.

5. The light and vision blocking venetian blind system, as defined in claim 4, wherein each of said end channels further comprises a front and a rear end slat,
each of said front and rear end slats having a length substantially equal to the height of said window opening, minus a height of said top rail, and
each of said front and rear end slats is hingably attached interior of said front and rear end rails,
such that, as said blind is opened and closed, a swinging edge of each of said end slats remain in movable contact with said slats and said bottom rail, thereby restricting light infiltration and line of sight vision around said ends of said blind.

6. The light and vision blocking venetian blind system, as defined in claim 1, wherein said horizontal constrainment means comprises a sill channel, said sill channel further comprising:
a bottom plate having a length and a width, and
a front and a rear channel wall,
said front and rear channel walls being substantially normal to a and abutting each of the two length edges of said bottom plate, thereby generally forming a “U” shape, said sill channel being mountable to the sill of said window opening such that said bottom rail is constrained within said “U”, thereby limiting the free movement of said bottom rail and restricting light infiltration and line of sight vision around the bottom of said blind.
